(19) United States
(12) Patent Application Publication
(10) Pub. No.: US 2015/0369902 A1
(43) Pub. Date: Dec. 24, 2015

(54) AMUSEMENT PARK MANAGEMENT SYSTEM AND METHOD

(71) Applicant: SAMSUNG ELECTRO-MECHANICS CO., LTD., Suwon-Si (KR)

(72) Inventors: Min Keun KIM, Suwon-Si (KR); Sang Hoon Kim, Suwon-Si (KR)

(73) Assignee: SAMSUNG ELECTRO-MECHANICS CO., LTD., Suwon-Si (KR)

(21) Appl. No.: 14/623,485

(22) Filed: Feb. 16, 2015

(30) Foreign Application Priority Data
Jun. 23, 2014 (KR) 10-2014-0076366

(51) Int. Cl. G01S 5/04

(52) U.S. Cl. CPC G01S 5/04

(57) ABSTRACT

An amusement park management system may include at least one portable terminal apparatus including identification information and providing the identification information using a preset wireless communications scheme, a plurality of repeaters receiving the identification information provided from the portable terminal apparatus and detecting distance information of the portable terminal apparatus providing the identification information, and a server apparatus receiving the distance information provided from the plurality of repeaters and detecting coordinate information of the portable terminal apparatus providing the identification information.

### CROSS-REFERENCE TO RELATED APPLICATION

This application claims the benefit of Korean Patent Application No. 10-2014-0076366, filed on Jun. 23, 2014, with the Korean Intellectual Property Office, the disclosure of which is incorporated herein by reference.

### BACKGROUND

Some embodiments of the present disclosure may relate to an amusement park management system and method.

Recently, in accordance with growth in the area of amusement parks, visitor numbers have increased in the amusement parks. However, since the number of persons able to be accommodated by individual amusement park rides is limited, visitor dissatisfaction with amusement park experiences has increased. Particularly, visitors may generally wait for 1 to 2 hours for a single ride. In order to address this problem, various convenience facilities are present within amusement parks, and various events and performances may occur therein. However, waiting times may not be directly decreased.

In addition, the frequency of lost or missing children in amusement parks has increased, due to increases in visitor numbers, and amusement park personnel for searching for lost or missing children may not be adequately provided when the frequency of missing or lost children is considered.

Therefore, accurate information may need to be provided to amusement park visitors in order to solve the problems of visitor dissatisfaction as described above. Prior to this, accurate recognition of positional information related to visitors may be needed.

### RELATED ART DOCUMENT

(Patent Document 1) Korean Patent Laid-Open Publication No. 10-2006-0097365

### SUMMARY

An exemplary embodiment in the present disclosure may provide an amusement park management system and method capable of providing service information by receiving distance information of a portable terminal apparatus from at least three repeaters and accurately detecting coordinate information of the portable terminal apparatus using the distance information.

According to an exemplary embodiment in the present disclosure, an amusement park management system may include: at least one portable terminal apparatus including identification information and providing the identification information using a preset wireless communications scheme; a plurality of repeaters receiving the identification information provided from the portable terminal apparatus using the preset wireless communications scheme and detecting distance information by transmitting data to and receiving data from the portable terminal apparatus providing the identification information; and a server apparatus receiving the distance information provided from at least three of the plurality of repeaters and detecting coordinate information of the portable terminal apparatus providing the identification information.

According to another exemplary embodiment in the present disclosure, an amusement park management method may include: providing, by a portable terminal apparatus, identification information to a plurality of repeaters using a preset wireless communications scheme; determining, by at least three of a plurality of repeaters, distance information by transmitting data to and receiving data from the portable terminal apparatus; providing the distance information determined by each of the repeaters to a server apparatus; and detecting, by the server apparatus, coordinate information of the portable terminal apparatus using distance information provided from each of the repeaters.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram illustrating an amusement park management system according to an exemplary embodiment of the present disclosure;

FIGS. 2A and 2B are views illustrating examples to which the amusement park management system shown in FIG. 1 is actually applied;

FIG. 3 is a view for describing a method of detecting coordinate information in the amusement park management system shown in FIG. 1;

FIG. 4 is a view illustrating an example of service information provided by a server apparatus in the amusement park management system shown in FIG. 1;

FIG. 5 is a block diagram illustrating the server apparatus in the amusement park management system shown in FIG. 1; and

FIG. 6 is a flow chart illustrating an amusement park management method according to another exemplary embodiment of the present disclosure.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

Throughout the drawings, the same or like reference numerals will be used to designate the same or like elements.

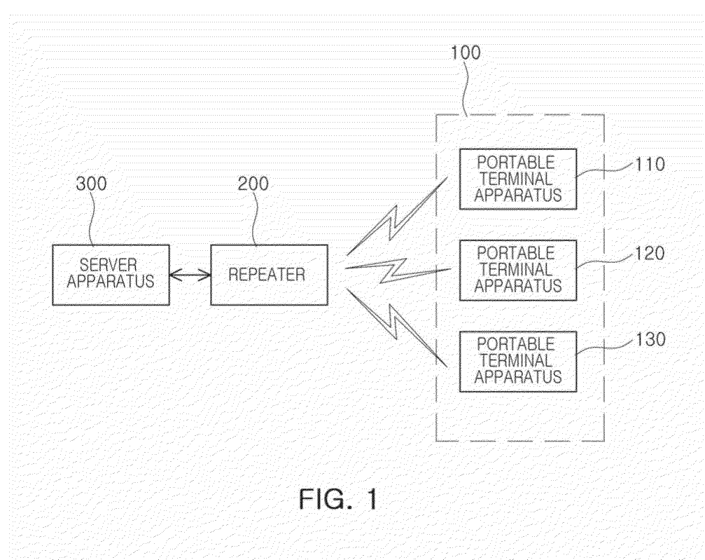

FIG. 1 is a block diagram illustrating an amusement park management system according to an exemplary embodiment of the present disclosure.

Referring to FIG. 1, the amusement park management system according to the exemplary embodiment of the present disclosure may include one or more portable terminal apparatuses 100, one or a plurality of repeaters 200, and a server apparatus 300. For illustration purposes, in FIG. 1, a case in which the number of portable terminal apparatuses 100 is plural is illustrated. Hereinafter, one portable terminal apparatus 110 of the portable terminal apparatuses 100 will mainly be described for ease explanation.

The portable terminal apparatus 110 may include identification information. The identification information may include, for example, but not limited to, received signal strength indication (RSSI) information and media access control (MAC) address information.

For instance, the plurality of repeaters 200 or the server apparatus 300 may identify each of the portable terminal apparatuses 100 using the MAC address information. In addition, the portable terminal apparatus 110 may provide the identification information to the plurality of repeaters 200 using a preset wireless communications scheme.

For example, the preset wireless communications scheme may be a Zigbee communications scheme. In more detail, the Zigbee communications scheme may be based on IEEE 802.15.4, and the server apparatus 300 and the plurality of repeaters 200 or the plurality of repeaters 200 and the portable terminal apparatus 110 may form a wireless network using the Zigbee communications scheme, but not limited thereto.

Meanwhile, 1000 or more portable terminal apparatuses within a radius of 50 meter may access or be connected to one repeater 210 as an example, and the plurality of repeaters 200 may be installed depending on a layout of the amusement park.

One or the plurality of repeaters 200 may receive the identification information provided from the portable terminal apparatus 110. In addition, the plurality of repeaters 200 may determine distance information of the portable terminal apparatus 110 providing the identification information.

For instance, one or the plurality of repeaters 200 may measure or estimate a radius distance to the portable terminal apparatus 110 using the RSSI information provided from the portable terminal apparatus 100. After the radius distance is measured, one or the plurality of repeaters 200 may detect distance information of the portable terminal apparatus 110 positioned within the radius distance using the MAC address information.

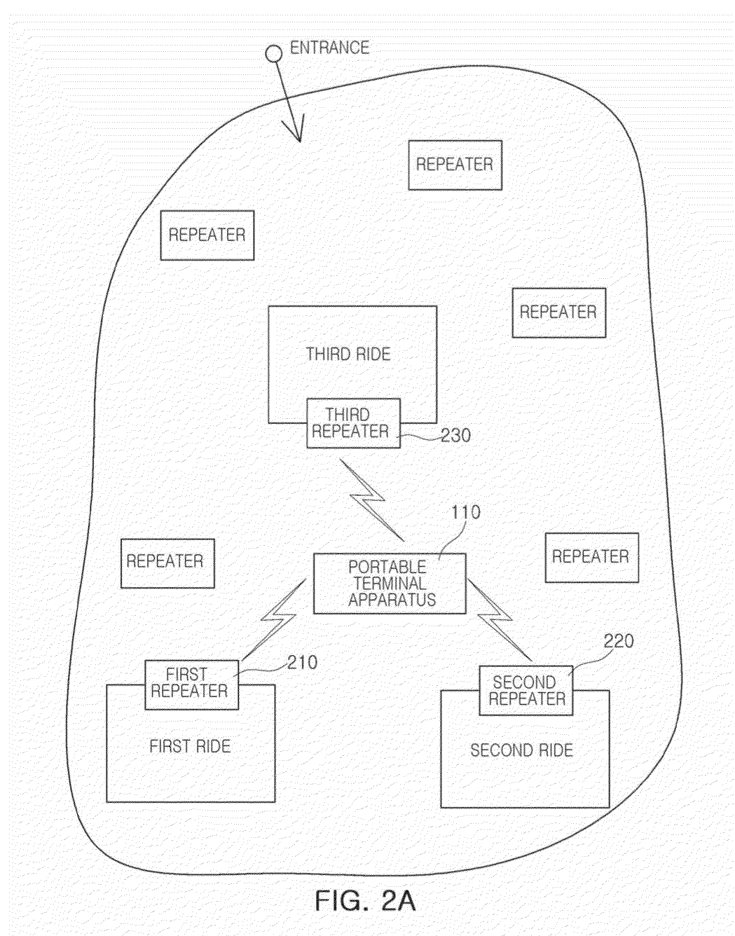

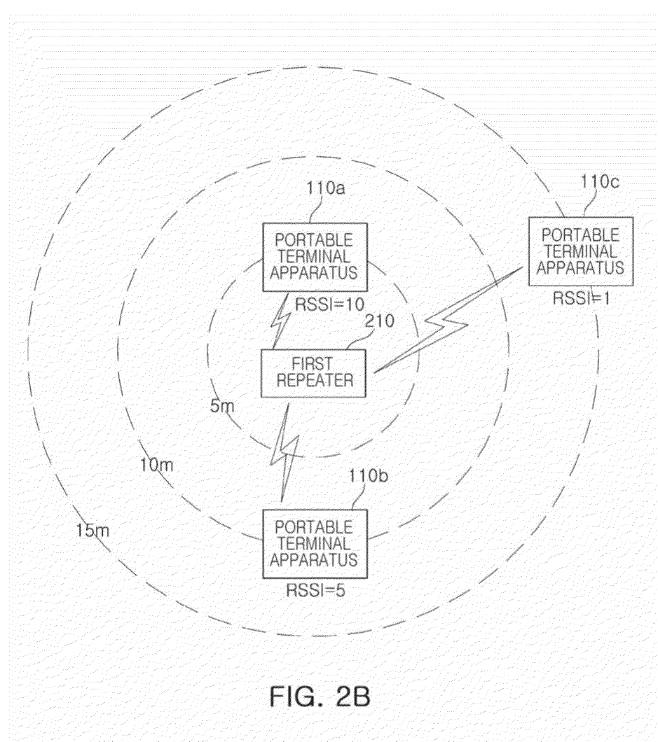

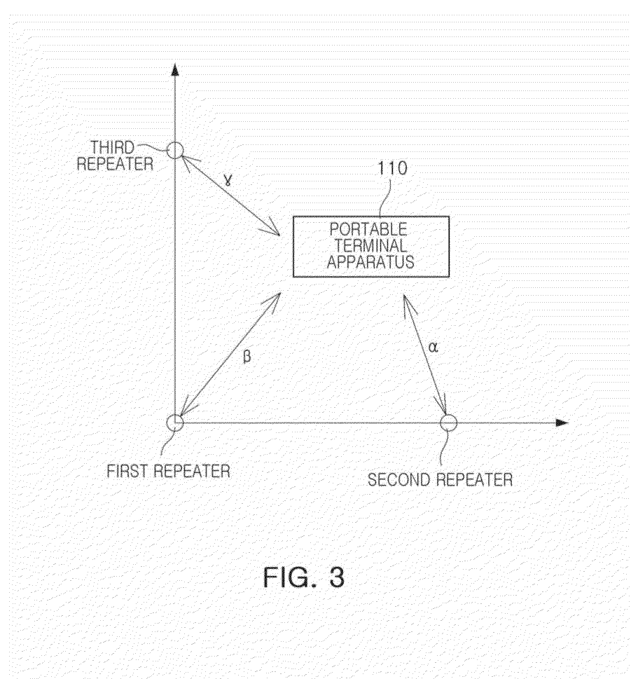

A description thereof will be provided below with reference to FIGS. 2A through 3.

The server apparatus 300 may receive the distance information provided from at least three of the plurality of repeaters 200. Then, the server apparatus 300 may detect coordinate information of the portable terminal apparatus 110 providing the identification information using the distance information provided from the at least three repeaters 200.

FIGS. 2A and 2B are views illustrating an example to which the amusement park management system shown in FIG. 1 is actually applied.

The amusement park management system according to exemplary embodiments of the present disclosure will be described in detail with reference to FIGS. 2A and 2B.

First, referring to FIG. 2A, repeaters 200 may be disposed at appropriate places depending on a surrounding environment of the amusement park. For example, the repeaters 200 may comprise a first repeater 210, a second repeater 220 and a third repeater 330 which may be installed in locations in which first to third rides are located. The repeaters 200 may periodically transmit and receive data to and from the portable terminal apparatuses 100 accessing the respective repeaters 200 using Zigbee communications.

The portable terminal apparatus 110 may access the first to third repeaters 210 to 230 using the Zigbee communications to transmit data to and to receive data from the first to third repeaters 210 to 230. Here, the portable terminal apparatus 110 may include unique identification information and provide the identification information to at least one or all of the first to third repeaters 210 to 230. Here, although the case in which the portable terminal apparatus 110 accesses three repeaters has been described by way of example, the portable terminal apparatus 110 may access four or more repeaters 200. In addition, the first to third repeaters 210 to 230 may be fixed-type repeaters fixed in predetermined positions or movable-type repeaters movable within preset ranges.

A process of receiving the identification information will be described in more detail with reference to FIG. 2B.

Referring to FIG. 2B, the first to third repeaters 210 to 230 may receive the identification information provided from the portable terminal apparatus 110. In addition, in a process of transmitting data using the Zigbee communications, the first to third repeaters 210 to 230 may measure the radius distance to the portable terminal apparatus 110 using, for example, but not limited to, the RSSI information provided from the portable terminal apparatus 110.

For example, in the case in which the RSSI is 5, the radius distance may be 10 meter from the portable terminal apparatus 110a to the first repeater 210, in the case in which the RSSI is 10, the radius distance may be 5 meter from the portable terminal apparatus 110b to the first repeater 210, and in the case in which the RSSI is 1, the radius distance may be 15 meter from the portable terminal apparatus 110c to the first repeater 210.

Then, the first to third repeaters 210 to 230 may detect the distance information to the portable terminal apparatus 110 using the measured radius distance and the MAC address information provided from the portable terminal apparatus 110.

Here, the first to third repeaters 210 to 230 may provide the measured distance information to the server apparatus 300 (See FIG. 1). The server apparatus 300 may detect the coordinate information of the portable terminal apparatus 110 providing the identification information using the distance information provided from the first to third repeaters 210 to 230.

In the case in which the portable terminal apparatus 110 additionally accesses other repeater(s) other than the first to third repeaters 210 to 230 as an example, the server apparatus 300 may receive distance information of each of the repeaters 200, select three repeaters positioned at the shortest distance from the portable terminal apparatus 110, and detect the coordinate information.

Here, receiving the distance information from at least three repeaters may be used to detect coordinate information of the portable terminal apparatus 110 using a triangulation. For example, the amusement park management system according to the exemplary embodiment of the present disclosure may detect the coordinate information of the portable terminal apparatus 110 using triangulation to recognize a more accurate position.

FIG. 3 is a view for describing a method of detecting coordinate information in the amusement park management system shown in FIG. 1.

Referring to FIG. 3, in the case that a distance between the first repeater 210 and the portable terminal apparatus 110 is α, a distance between the second repeater 220 and the portable terminal apparatus 110 is β, and a distance between the third repeater 230 and the portable terminal apparatus 110 is γ, the server apparatus 300 (See FIG. 1) according to an exemplary embodiment of the present disclosure may detect the coordinate information of the portable terminal apparatus 110 using, for instance, but not limited to, triangulation. Here, the server apparatus 300 (See FIG. 1) may detect accurate coordinate information using map information of the amusement park pre-stored therein.

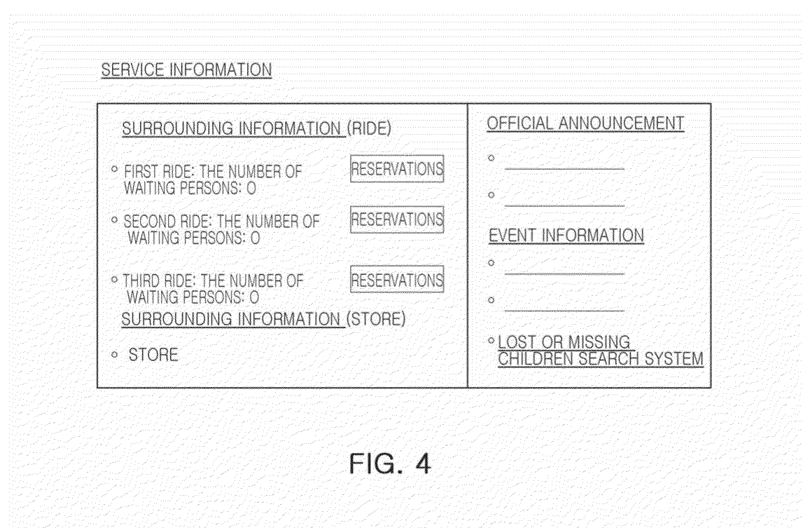

FIG. 4 is a view illustrating an example of service information provided by the server apparatus in the amusement park management system shown in FIG. 1.

Referring to FIG. 4, the server apparatus 300 (See FIG. 1) included in the amusement park management system according to the exemplary embodiment of the present disclosure may provide service information around the portable terminal apparatus 110 depending on the coordinate information through the first to third repeaters 210 to 230.

For instance, the service information may include current position information of the portable terminal apparatus 110, ride information and store information around the coordinate information, event information, lost or missing children search information, official announcements, any service or facility information and the like.

Referring to FIGS. 2A, 2B, and 4, a visitor may wear the portable terminal apparatus 110 on a wrist, or the like, and receive the service information provided from the server apparatus 300 (See FIG. 1). For example, it the visitor may know how many people are currently waiting for a first ride to determine whether or not to make a reservation therefor. In addition, the visitor may recognize the store information around a place at which he/she is currently positioned and may receive the official announcement and the event information.

Here, the portable terminal apparatus 110 may include a display unit and output the service information provided from the server apparatus 300 (See FIG. 1) through the display unit.

Meanwhile, the portable terminal apparatus 110 may be positioned on, for example, but not limited to, a wrist, any portion of the visitor's body or the like, of a child in advance, and accurate coordinate information may be detected using the portable terminal apparatus 110, thereby preventing lost or missing of children in the amusement park.

An exemplary embodiment of a method for the visitor to use the service information will be described in detail. First, the visitor may synchronize the MAC address information of the portable terminal apparatus 110 and personal information with each other. For example, the personal information may include a personal phone number, a date of birth, and/or the like. The MAC address information may be provided together with the RSSI information to the server apparatus 300 through at least one of the plurality of repeaters 200, and the personal information may be registered in the server apparatus 300.

The server apparatus 300 may detect the distance information to the portable terminal apparatus 110 and provide various types of service information to the portable terminal apparatus 110 depending on the distance information.

For example, in the case in which a plurality of visitors are gathered in a specific region, the service information including a specific event, or the like, may be provided to those visitors to disperse the visitors, and information on various stores, restaurants, or the like, may be included in the service information. Further, in the case in which the visitor makes a reservation with respect to a specific ride in advance, he/she may receive reservation information provided from the server apparatus 300, and in the case in which an article or a child is lost or missing, service information including information indicating that the article or the child is lost or missing may be provided to the portable terminal apparatus(es) 100 of the visitor to increase convenience of the visitor.

Meanwhile, in the case in which the visitor exits the amusement park, the MAC address information and the visitor information synchronized with each other may be desynchronized from each other to delete personal visitor information from the server apparatus 300.

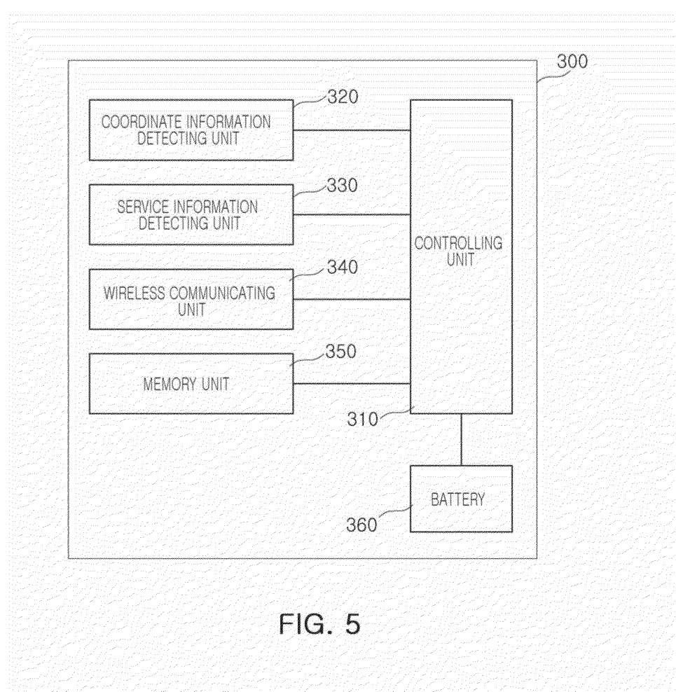

FIG. 5 is a block diagram illustrating the server apparatus in the amusement park management system shown in FIG. 1.

The server apparatus 300 may include a controlling unit 300, a coordinate information detecting unit 320, a service information detecting unit 330, a wireless communicating unit 340, a memory unit 350, and a battery 360.

The coordinate information detecting unit 320 may detect the coordinate information of the portable terminal apparatus 110 by comparing the distance information provided from the plurality of repeaters 200 with the map information of the amusement park pre-stored in the memory unit 350.

The service information detecting unit 330 may detect or search the service information by comparing the coordinate information with the pre-stored map information of the memory unit 350, and provide or transmit the detected service information to the portable terminal apparatus 110 through one or the plurality of repeaters 200.

In addition, the server apparatus 300 may include the wireless communicating unit 340 to perform wireless communications with the plurality of repeaters 200. Here, a wireless communications scheme may be, for example, but not limited to, a Zigbee communications scheme, and the server apparatus 300 may perform the Zigbee communications with at least three repeaters 200.

The memory unit 350 may pre-store the map information on the amusement park and surrounding service information corresponding to the map information therein.

Meanwhile, the battery 360 may supply driving power to the server apparatus 300.

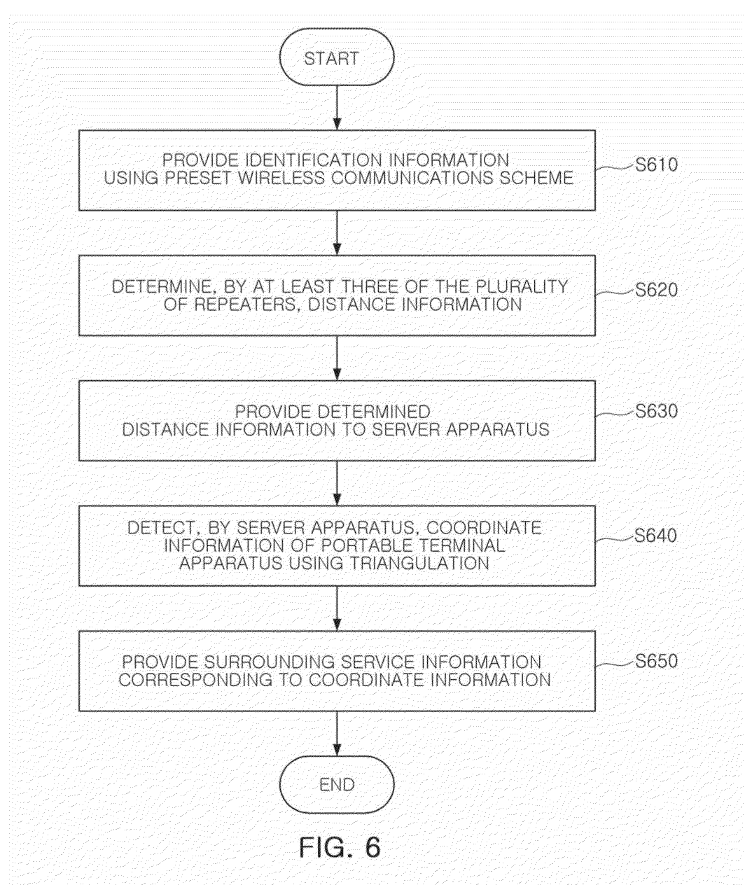

FIG. 6 is a flow chart illustrating an amusement park management method according to another exemplary embodiment of the present disclosure.

An amusement park management method according to another exemplary embodiment of the present disclosure may include at least one of steps of providing, by the portable terminal apparatus 110, the identification information to the plurality of repeaters 200 using the preset wireless communications scheme (S610), determining, by at least three of the plurality of repeaters 200, the distance information by transmitting data to and receiving the data from the portable terminal apparatus 110 (S620), providing the distance information determined by each of at least three repeaters to the server apparatus 300 (S630), and detecting, by the server apparatus 300, the coordinate information of the portable terminal apparatus 110 using each of the distance information provided from at least three repeaters 200 (S640).

Here, at least three repeaters 200 may measure the radius distance to the portable terminal apparatus 110 using, for example, but not limited to, the RSSI information provided from the portable terminal apparatus 110.

Then, at least three repeaters 200 may detect the distance information to the portable terminal apparatus 110 using the measured radius distance and the MAC address information provided from the portable terminal apparatus 110.

In addition, the coordinate information may be detected by, for instance, but not limited to, triangulation using each of the distance information provided from the at least three repeaters 200.

Meanwhile, the amusement park management method according to another exemplary embodiment of the present disclosure may further include providing, by the server apparatus 300, the surrounding service information corresponding to the coordinate information to the portable terminal apparatus 110 (S650). For example, the service information may include the current position information of the portable terminal apparatus, surrounding ride information and store information as well as coordinate information, event information, lost or missing children search information, the official announcement and any service or facility information, as described above, but not limited thereto.

As set forth above, with the amusement park management system and method according to some exemplary embodiments in the present disclosure, each of at least three repeaters 200 may determine the distance information to the portable terminal apparatus(es) 100, and the server apparatus 300 may detect the accurate coordinate information of the portable terminal apparatus(es) 100 using the distance information and provide the service information, whereby convenience of the visitor may be increased and information may be more accurately provided to the visitor.

While exemplary embodiments have been shown and described above, it will be apparent to those skilled in the art that modifications and variations could be made without departing from the scope of the present invention as defined by the appended claims.

What is claimed is:

1. An amusement park management system comprising:
at least one portable terminal apparatus including identification information and providing the identification information using a preset wireless communications scheme;
a plurality of repeaters receiving the identification information and detecting distance information of the portable terminal apparatus; and
a server apparatus receiving the distance information provided from at least three of the repeaters and detecting coordinate information of the portable terminal apparatus.

2. The amusement park management system of claim 1, wherein the preset wireless communications scheme includes a Zigbee communications scheme.

3. The amusement park management system of claim 1, wherein the server apparatus detects the coordinate information by a triangulation using the distance information of the portable terminal apparatus provided from the repeaters.

4. The amusement park management system of claim 1, wherein:
the server apparatus provides surrounding service information to the portable terminal apparatus depending on the coordinate information, and
the service information includes at least one or more of current position information of the portable terminal apparatus, ride information and store information around the coordinate information, event information, lost or missing children search information, and official announcement.

5. The amusement park management system of claim 4, wherein the portable terminal apparatus includes a display unit outputting the service information provided from the server apparatus.

6. The amusement park management system of claim 1, wherein the repeaters include one or both of a fixed-type repeater fixed to a predetermined position and a movable-type repeater movable in a preset range.

7. The amusement park management system of claim 1, wherein the server apparatus includes:
a battery providing driving power;
a coordinate information detecting unit detecting the coordinate information using the distance information provided from the repeaters;
a service information detecting unit detecting service information by comparing the coordinate information with pre-stored map information;
a wireless communicating unit providing the service information to the three repeaters; and
a memory unit storing the map information and the service information.

8. The amusement park management system of claim 1, wherein the identification information includes received signal strength indication (RSSI) information and media access control (MAC) address information.

9. The amusement park management system of claim 8, wherein the repeaters measure a radius distance to the portable terminal apparatus using the RSSI information provided from the portable terminal apparatus and detect the distance information of the portable terminal apparatus positioned in the radius distance using the MAC address information.

10. An amusement park management method comprising:
providing, by a portable terminal apparatus, identification information to a plurality of repeaters using a preset wireless communications scheme;
determining, by at least three of the plurality of repeaters, distance information of the portable terminal apparatus;
providing the distance information determined by the repeaters to a server apparatus; and
detecting, by the server apparatus, coordinate information of the portable terminal apparatus using distance information provided from the repeaters.

11. The amusement park management method of claim 10, wherein the preset wireless communications scheme includes a Zigbee communications scheme.

12. The amusement park management method of claim 10, wherein the detecting of the coordinate information includes detecting the coordinate information by a triangulation using the distance information provided from the repeaters.

13. The amusement park management method of claim 10, wherein the identification information includes RSSI information and MAC address information.

14. The amusement park management method of claim 13, wherein the determining of the distance information includes:
measuring a radius distance to the portable terminal apparatus using the RSSI information provided from the portable terminal apparatus; and
detecting the distance information of the portable terminal apparatus positioned in the radius distance using the MAC address information.

15. The amusement park management method of claim 10, further comprising providing, by the server apparatus, surrounding service information corresponding to the coordinate information to the portable terminal apparatus,
wherein the service information includes at least one or more of current position information of the portable terminal apparatus, ride information and store information around the coordinate information, event information, lost or missing children search information, and official announcement.

16. The amusement park management method of claim 13, further comprising receiving, by the portable terminal apparatus, the service information and outputting the service information on a screen.
